(19) United States
(12) Patent Application Publication
(10) Pub. No.: US 2026/0355659 A1
(43) Pub. Date: Nov. 12, 2026

(54) MOLTEN METAL FILTRATION UNIT

(71) Applicant: MITSUI KINZOKU COMPANY, LIMITED, Tokyo (JP)

(72) Inventors: Kensuke NAKAMOTO, Omuta (JP); Eiki TSUTSUMI, Omuta (JP); Kazuhiko KAWAGUCHI, Omuta (JP); Minoru TAKAOKA, Omuta (JP); Shinichi MATSUNAGA, Omuta (JP)

(73) Assignee: MITSUI KINZOKU COMPANY, LIMITED, Tokyo (JP)

(21) Appl. No.: 19/116,656

(22) PCT Filed: Nov. 30, 2023
(86) PCT No.: PCT/JP2023/042950

§ 371 Date: Mar. 28, 2025

(51) Int. Cl. B01D 29/52; B01D 29/15; B01D 39/20; B22D 43/00

(52) U.S. Cl. CPC B01D 29/52; B01D 29/15; B01D 39/2068; B22D 43/005

(57) ABSTRACT

The present invention is a molten metal filtration unit comprising two or more cylindrical ceramic filtration tubes arranged approximately in parallel and each having an approximately circular cross-sectional shape perpendicular to a longitudinal direction on an outer surface and an inner surface and a pair of side plates arranged at both ends of the two or more ceramic filtration tubes in the longitudinal direction, in which the two or more ceramic filtration tubes have a first end portion on a side from which a molten metal exits and a second end portion on the other side, and when a length in the longitudinal direction of a portion exposed to the molten metal on an outer surface of the filtration tube is L1, an outer diameter of the filtration tube is D1, a length in the longitudinal direction of a portion exposed to the molten metal on an inner surface of the filtration tube is L2, and an inner diameter of the filtration tube is D2, at least one of the two or more ceramic filtration tubes satisfies both of the following two relational expressions: (i) L1/D1≥8.5 (ii) L2/D2≤21.

### TECHNICAL FIELD

The present invention relates to a molten metal filtration unit for filtering a molten metal such as aluminum.

### BACKGROUND ART

Molten metal such as aluminum used in the production of castings usually contains nonmetallic inclusions such as hydrogen and oxides as impurities. For example, dissolved hydrogen in the molten metal forms a casting cavity called porosity in the casting, and oxides and the like can be inclusions in the casting. These casting cavities and inclusions are not preferable because they can serve as a fracture starting point in the casting. Therefore, filtration devices for filtering a molten metal and removing inclusions and the like contained in the molten metal have been developed.

In order to achieve this object, typically, a molten metal filtration apparatus has been used in which a molten metal filtration unit having two or more ceramic filtration tubes for filtering impurities from a molten metal is placed in a filtration chamber having an entrance and a discharging port (see, for example, Patent Literature 1). Such a molten metal filtration unit generally includes two or more ceramic filtration tubes and a pair of side plates arranged approximately in parallel to each other at both ends in the longitudinal direction of the two or more filtration tubes. The molten metal introduced into the filtration chamber from the entrance of the filtration chamber flows into the filtration tubes from the peripheral wall surface of the filtration tubes provided with one of the side plates, where impurities are filtered out. The molten metal flows out from the opposite end of the filtration tubes provided with the other side plate, and then exits from the discharging port of the filtration chamber.

For the purpose of improving the treatment capability and efficiency in the molten metal filtration unit, attempts have been made to increase the amount of molten metal passing through the filtration unit and to extend the service life of the filtration tubes. As an example of such an attempt, there has been reported a molten metal filtration unit where a ratio of an interval between adjacent recesses formed in one of a pair of side plates into which two or more filtration tubes are each inserted and held to a depth of the recesses is controlled to fall within a predetermined range, and at the same time, the interval between the adjacent recesses is controlled to fall within a predetermined range (see Patent Literature 2). It is considered in the literature that an effect of being capable of increasing the filtration efficiency while maintaining the strength of the side plates can be obtained by configuring the two or more filtration tubes and the recesses corresponding thereto as described above.

### CITATION LIST

### Patent Literature

PATENT LITERATURE 1: JP-A-H7-4868
PATENT LITERATURE 2: JP-B-6295108

### SUMMARY OF INVENTION

### Technical Problem

However, in the technique of arranging the two or more tubes inserted into the recesses of the side plates as densely as possible while taking into account the strength of the side plates as in the molten metal filtration unit reported in Patent Literature 2, it is desirable to further increase the number of filtration tubes in order to further increase the amount of molten metal passing through the filtration unit and further extend the service life of the filtration tubes. However, when the number of filtration tubes is excessively increased, it is necessary to form a large number of recesses corresponding to the filtration tubes and a large number of through-holes on the discharging side in the side plate, so that there is a disadvantage that it may be difficult to maintain sufficient strength of the side plate.

Therefore, one object to be achieved by the present invention is to provide a novel molten metal filtration unit that has not been reported in the prior art.

Further, a further object of the present invention is to provide a novel molten metal filtration unit in which the above disadvantage is solved, that is, high strength of the side plate is maintained, and at the same time, the amount of molten metal passing through the filtration unit can be further increased, the molten metal can be stably filtered with the increased amount passing through the filtration unit, and the service life of the filtration tube can be further extended.

### Solution to Problem

As a result of intensive studies, the present inventors have found that in a molten metal filtration unit including two or more cylindrical ceramic filtration tubes and a pair of side plates disposed at both ends in the longitudinal direction thereof, the above object can be solved by controlling the ratio L₁/D₁ of the longitudinal length L₁ of the portion of the outer surface of the filtration tube exposed to the molten metal to the outer diameter D₁ of the filtration tube to a specific lower limit or more and controlling the ratio L₂/D₂ of the longitudinal length L₂ of the portion of the inner surface of the filtration tube exposed to the molten metal to the inner diameter D₂ of the filtration tube to a specific upper limit or less in at least one of the two or more filtration tubes.

That is, the present inventors have found that, according to the molten metal filtration unit having such a configuration, by increasing the area of the exposed portion of the outer surface of the filtration tube to the molten metal and securing a certain size as the inner diameter of the filtration tube, the amount of the molten metal passing through the filtration unit (i.e., the flow rate of the molten metal) can be further increased, and by reducing the amount of molten metal passing through the filtration unit per unit area of the filtration tubes, the service life of the filtration tubes can be further extended, thereby completing the present invention.

A typical aspect of the present invention is as follows.

A molten metal filtration unit, comprising:
two or more cylindrical ceramic filtration tubes arranged approximately in parallel and each having an approximately circular cross-sectional shape perpendicular to a longitudinal direction on an outer surface and an inner surface; and
a pair of side plates arranged at both ends of the two or more ceramic filtration tubes in the longitudinal direction,
wherein
the two or more ceramic filtration tubes each have a first end portion on a side from which a molten metal exits and a second end portion on the other side, and
when a length in the longitudinal direction of a portion exposed to the molten metal on an outer surface of the filtration tube is L₁, an outer diameter of the filtration tube is D₁, a length in the longitudinal direction of a portion exposed to the molten metal on an inner surface of the filtration tube is L₂, and an inner diameter of the filtration tube is D₂, at least one of the two or more ceramic filtration tubes satisfies both of the following two relational expressions:

L₁/D₁≥8.5 (1)

L₂/D₂≤21. (2)

### Advantageous Effects of Invention

According to the present invention, a novel molten metal filtration unit that has not been reported in the prior art is provided.

Furthermore, according to the molten metal filtration unit of a preferred aspect of the present invention, advantageously, it is possible to simultaneously achieve further increase in the amount of molten metal passing and stable filtration with the increased amount of molten metal passing, and further extension of the service life of the filtration tubes while highly maintaining the strength of the side plate, and the amount of treatment in the molten metal filtration unit can be increased and the treatment efficiency can be improved.

### BRIEF DESCRIPTION OF DRAWINGS

FIG. 1(a) is a schematic view of a molten metal filtration unit according to an embodiment of the present invention.

FIG. 1(b) is a schematic cross-sectional view illustrating a mechanism in which a molten metal is subjected to a filtration operation in a molten metal filtration unit according to an embodiment of the present invention.

FIG. 2 is a partial cross-sectional view including a ceramic filtration tube having a first end portion on a side of the tube from which a molten metal is discharged and a second end portion on the other side of the tube and a pair of side plates disposed at both ends in a longitudinal direction of the ceramic filtration tube in the molten metal filtration unit according to an embodiment of the present invention.

FIG. 3 is a cross-sectional view of a ceramic filtration tube of a molten metal filtration unit according to a variant embodiment of the present invention.

FIGS. 4(a) and 4(b) are views illustrating a relationship between an opening portion of a first end portion of a ceramic filtration tube on a side from which a molten metal is discharged and an approximately circular through hole made in a side plate placed on a discharging side in a molten metal filtration unit according to an embodiment of the present invention. FIG. 4(a) is a cross-sectional view seen from a longitudinal direction, and FIG. 4(b) is a cross-sectional view seen from a horizontal direction perpendicular to the longitudinal direction.

FIG. 5 is a cross-sectional view illustrating an example of the relationship between the inner diameter of a filtration tube arrangement side and the inner diameter of an end portion on the discharging side in an approximately circular through hole made in a side plate placed on the discharging side of a molten metal filtration unit according to an embodiment of the present invention.

FIG. 6 is a cross-sectional view for illustrating head heights T₀ and T₁ of a molten metal for evaluating filtration performance of a molten metal filtration unit according to an embodiment of the present invention in examples described later.

### DESCRIPTION OF EMBODIMENTS

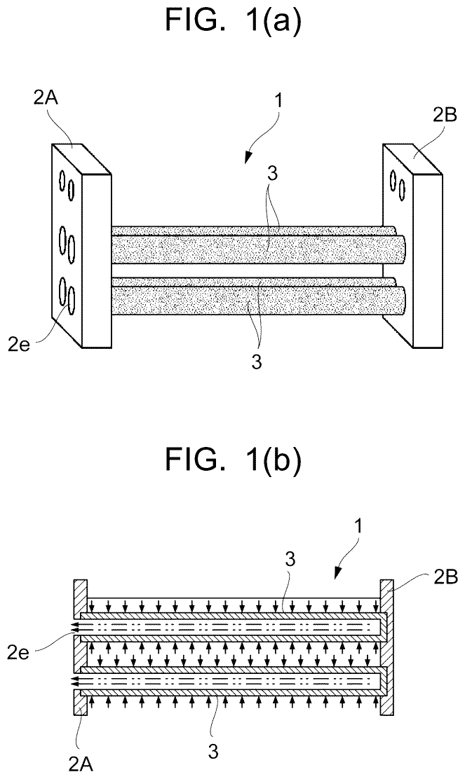

First, a structure of a molten metal filtration unit according to an embodiment of the present invention and an outline of molten metal filtration will be described with reference to FIGS. 1(a) and 1(b). The configuration illustrated in these drawings is a simplified example for the sake of explanation, and the molten metal filtration unit of the present invention is not limited thereto.

In FIGS. 1(a) and (b), reference sign 1 denotes a molten metal filtration unit, reference signs 2A and 2B denote a pair of side plates arranged at both ends of the filtration unit (the side plate arranged on the side from which the molten metal is discharged and the side plate arranged on the opposite side, respectively), reference sign 3 denotes two or more ceramic filtration tubes for filtering impurities from the molten metal (hereinafter, sometimes simply referred to as “filtration tubes”), and reference sign 2e denotes through holes in the side plate placed on the discharging side. Although not illustrated in the drawing, a packing having a shape that can be fitted with each end of the filtration tube and the corresponding side plate may be disposed between each end of the filtration tube and the corresponding side plate. It is not essential to provide such a packing, but it is preferable to provide the packing from the viewpoint of enabling the filtration tube to be stably fixed to the side plate and enabling the leakage of the molten metal to be reliably prevented. The two or more ceramic filtration tubes 3 are disposed approximately in parallel to each other, and each has a cylindrical shape whose cross-sectional shape perpendicular to the longitudinal direction is approximately circular on the outer surface and the inner surface. The filtration tube 3 is generally formed of a porous material made of ceramics. As indicated by arrows illustrated in FIG. 1(b), the molten metal flows between the inner surface and the outer surface of the filtration tubes 3, whereby foreign matters contained in the molten metal can be filtered off and removed. Then, the purified metal of the molten metal subjected to the filtration treatment for foreign matters is discharged from the through holes 2e of the side plate placed on the discharging side.

In the molten metal filtration unit 1 of FIGS. 1(a) and 1(b), for ease of explanation, a structure in which only four ceramic filtration tubes 3 are disposed is illustrated as an example, but the present invention is not limited thereto. The number of the ceramic filtration tubes 3 is not particularly limited as long as it is plural, and may be, for example, 2 to 50, or 3 to 40, or 4 to 30, or 5 to 20. As illustrated in the drawing, the cross-sectional shape of the ceramic filtration tubes 3 is usually approximately circular, but may be a hybrid partially including a cross-sectional shape other than an approximately circular shape such as a flat and approximately elliptical shape or an approximately rectangular shape. In the case of such hybridization, the proportion of the filtration tubes having a cross-sectional shape other than an approximately circular shape may be less than a half of all the filtration tubes, for example, less than ⅓. The two or more ceramic filtration tubes 3 are usually arranged approximately horizontally at approximately equal intervals, but adjacent ceramic filtration tubes may be in direct contact with each other in part. In a case where the ceramic filtration tubes 3 laterally arranged in an approximately horizontal shape at approximately equal intervals form two or more rows, it is preferable that the two or more rows are also arranged at approximately equal intervals.

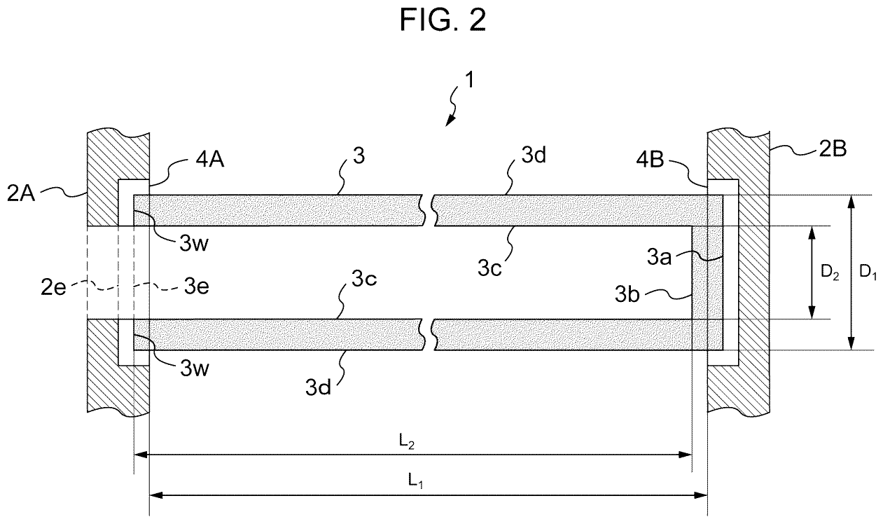

FIG. 2 is a cross-sectional view of the molten metal filtration unit according to one embodiment of the present invention as viewed perpendicularly to the longitudinal direction of the filtration tube. In the molten metal filtration unit of the embodiment of FIG. 2, although a part of the ceramic filtration tube is omitted for convenience of illustration, the molten metal filtration unit may have a configuration in which the molten metal filtration unit is further extended in the longitudinal direction as compared with the illustration in the drawing.

In FIG. 2, reference sign 1 denotes a molten metal filtration unit, reference sign 2A denotes a side plate placed on the side from which the molten metal is discharged, reference sign 2B denotes a side plate placed on the opposite side to the discharge side (this side plate has no through holes and is closed), reference sign 2e denotes an approximately circular through hole made in the side plate placed on the discharge side, reference sign 3 denotes a cylindrical ceramic filtration tube with approximately circular cross-sections perpendicular to the longitudinal direction on both the outer and inner surfaces, reference sign 3a denotes an approximately circular outer end surface of the second end portion of the filtration tube, reference sign 3b denotes an approximately circular inner end surface of the second end portion of the filtration tube, reference sign 3c denotes a portion of the inner surface of the filtration tube that is exposed to the molten metal, reference sign 3d denotes a portion of the outer surface of the filtration tube that is exposed to the molten metal, reference sign 3e denotes an approximately circular opening at the first end portion of the filtration tube, reference sign 3w denotes an annular end surface excluding the opening at the first end portion of the filtration tube, reference sign 4A denotes a packing for fixing the first end portion of the filtration tube, and reference sign 4B denotes a packing for fixing the second end portion of the filtration tube. In FIG. 2, for the sake of explanation, only one of the two or more ceramic filtration tubes 3 is illustrated. The ceramic filtration tube 3 is fixed to fit the side plate 2A on the molten metal discharging side and the side plate 2B on the opposite side to the molten metal discharging side, respectively, at the end surface 3w excluding the opening at the first end portion of the filtration tube 3 on the molten metal discharging side and the peripheral edge of the end surface 3w, and at the outer end surface 3a of the second end portion on the opposite side to the first end portion and the peripheral edge of the outer end surface 3a, with a recess (usually having a peripheral wall portion having an approximately circular profile) bored in each of the side plate 2A placed on the molten metal discharging side and the side plate 2B placed on the opposite side to the molten metal discharging side, via the packing 4A or the packing 4B. Here, both the recess bored in the side plate 2A and the packing 4A or both the recess bored in the side plate 2B and the packaging 4B are formed to conform to the shape of the first end portion on the side of the ceramic filtration tube 3 from which the molten metal discharges and the shape of the second end portion on the opposite side, respectively. The recess bored in the side plate 2A and the packing 4A have openings each corresponding to the opening of the filtration tube on the first end portion side.

The packing 4A and the packing 4B may be configured only of an adhering portion which is a flat plate-like body in contact with each of the end surfaces of the filtration tube 3. In such a configuration, the peripheral wall portion of the recess bored in each of the side plates has an approximately circular cross-sectional shape to conform to the shape of each of the first end portion and the second end portion of the filtration tube 3, and the tube outer diameter at each of the first end portion and the second end portion of the filtration tube 3 is approximately equal to the diameter of the peripheral wall portion of the recess bored in the corresponding side plate.

Alternatively, the packing 4A and the packing 4B may be configured by an adhering portion that is a flat plate in contact with each of the end surfaces of the filtration tube 3, and a sealing portion that is an annular body in contact with each edge portion of the outer surface of the filtration tube 3 and the peripheral wall portion of the recess bored in each of the side plates. These two portions of the packing may be integrally formed, or may be formed by connecting and joining two individual members. In such a configuration, the adhering portion of the packing has a function of absorbing a dimensional change in the longitudinal direction of the filtration tube due to expansion or contraction caused by surrounding conditions such as a controlled temperature of the molten metal, and keeping close contact between the filtration tube and the side plates. On the other hand, the sealing portion of the packing has a function of appropriately holding the shape of the entire molten metal filtration unit by sealing and joining the filtration tube and the side plates.

The adhering portion(s) of the packing 4A and/or the packing 4B may be fixed between the end portion of the filtration tube 3 and the side plate 2A and/or the side plate 2B in a compressed state with respect to the recess bored in the side plate 2A and/or the side plate 2B. The thickness(es) of the adhering portion(s) of the packing 4A and/or the packing 4B in the longitudinal direction of the filtration tube may be, for example, 5% or more and 80% or less, and preferably 10% or more and 70% or less, 15% or more and 60% or less, 18% or more and 50% or less, or 20% or more and 40% or less of the depth of the recess bored in the side plate 2A and/or the side plate 2B in the longitudinal direction of the filtration tube in the uncompressed state. When the adhering portion(s) of the packing 4A and/or the packing 4B is (are) compressed against the recess bored in the side plate 2A and/or the side plate 2B, the compression rate (i.e., the proportion of the thickness of the compressed portion relative to the thickness at the time of uncompression) may be, for example, more than 0% and 80% or less, 10% or more and 70% or less, 20% or more and 60% or less, or 30% or more and 50% or less. The thickness of the packing when compressed may be, for example, 2% or more and 50% or less, 4% or more and 40% or less, 5% or more and 30% or less, 6% or more and 20% or less, or 7% or more and 15% or less of the depth of the recess bored in the side plate 2A and/or the side plate 2B in the longitudinal direction of the filtration tube.

In the molten metal filtration unit 1 exemplified in FIG. 2, the shape of each of the side plate 2A on the side from which the molten metal is discharged and the side plate 2B on the side opposite to the molten metal discharging side is not particularly limited, as long as each of the side plate 2A and the side plate 2B has a recess bored so that each of the first end portion on the side from which the molten metal is discharged and the second end portion on the opposite side of the ceramic filtration tube 3 can be fitted and fixed via the packing 4A and the packing 4B. Each of the side plate 2A and the side plate 2B may usually have a flat plate shape. The bottom portion of each of the side plate 2A and the side plate 2B may be flat. Alternatively, in a case where the longitudinal direction of the filtration tube 3 is approximately horizontal, at least one of the side plate 2A and the side plate 2B may have a bottom portion formed such that one bottom side is positioned higher than the other bottom side in the vertical direction. When the molten metal filtration unit 1 is placed on the hearth (not illustrated in FIG. 2) of a molten metal filtration apparatus, if the bottom portion(s) of the side plate 2A and/or the side plate 2B is (are) configured in such a manner, the side end surface of the side plate 2A on the discharging side is pressed against the inner wall surface of the filtration apparatus by the weight of the filtration unit itself. Therefore, the filtration unit can be stably placed such that the through holes 2e of the side plate 2A on the discharging side and the discharging port provided on the inner wall surface of the filtration apparatus can reliably and continuously communicate with each other at an accurate position. Details of the embodiments related to the structure of the side plates will be described later in the following paragraphs.

In FIG. 2, the ceramic filtration tube 3 is illustrated as a cylindrical shape having approximately circular cross sections on the outer surface and the inner surface with each of the cross sections being constant totally from the second end portion to the first end portion.

In FIG. 2,
[i]. when the length in the longitudinal direction of the portion 3d exposed to the molten metal on the outer surface of the filtration tube 3, that is, the length in the longitudinal direction from the end point of the portion not covered with the side plate 2B and the packing 4B on the side opposite to the discharging side on the outer surface of the second end portion on the side opposite to the discharging side of the filtration tube 3 to the end point of the portion not covered with the side plate 2A and the packing 4A on the discharging side on the outer surface of the first end portion on the discharging side of the filtration tube 3 is set to L₁,
[ii]. the length in the longitudinal direction of the portion 3c exposed to the molten metal on the inner surface of the filtration tube 3, that is, the length in the longitudinal direction from the inner end surface 3b at the second end portion on the side opposite to the discharging side of the filtration tube 3 to the end surface 3w at the first end portion on the discharging side of the filtration tube 3 is set to L₂,
[iii]. the outer diameter of the filtration tube 3 (with the constant size from the second end portion to the first end portion in the drawing) is set to D₁, and
[iv]. the inner diameter of the filtration tube 3 (with the constant size from the second end portion to the first end portion in the drawing) is set to D₂,
the following relational expressions are usually satisfied:

L₁/D₁≥8.5 (1)

L₂/D₂≤21. (2)

Here, the “longitudinal direction” of the filtration tube 3 refers to a direction connecting the center of the outer peripheral circle of the end surface 3w at the first end portion on the discharging side and the center of the outer peripheral circle of the outer end surface 3a at the second end portion on the opposite side to the discharging side.

In addition, in a case where the “approximately circular shape” which is a cross-sectional shape perpendicular to the longitudinal direction on the outer surface and/or the inner surface of the filtration tube 3 is not a perfect circular shape, the outer diameter and/or the inner diameter is (are) determined by a circumscribed circle of the cross-sectional shape.

When the ceramic filtration tube 3 satisfies the above relational expression (1), the length in the longitudinal direction of the portion exposed to the molten metal on the outer surface of the filtration tube is controlled to extend to have a high ratio of a predetermined value or more to the outer diameter of the filtration tube, whereby the area of the outer exposed portion is increased, so that the amount of molten metal passing can be further increased, and more stable filtration can be performed even under the increased amount of molten metal passing. At the same time, the amount of molten metal passing per unit area of the filtration tube is reduced, whereby the service life of the filtration tube can be further extended, and consequently the filtration efficiency of the molten metal can be greatly improved.

In addition, when the ceramic filtration tube 3 satisfies the relational expression (2) in addition to the relational expression (1), the length in the longitudinal direction of the portion exposed to the molten metal on the inner surface of the filtration tube is controlled to have a ratio lowered to a predetermined value or less with respect to the inner diameter of the filtration tube, whereby the flow path of the molten metal (purified metal) subjected to the filtration treatment of foreign matters is sufficiently secured, so that an effect of promoting the flow of the purified metal to the discharging side, that is, an effect of enabling smooth flow of the increased molten metal can be obtained, and it is possible to achieve both such an effect and the above-described effect of improving the filtration efficiency of the molten metal. The combination of these effects is a great advantage.

In the above relational expression (1) L₁/D₁≥8.5, from the above viewpoint, L₁/D₁≥8.6, L₁/D₁≥8.7, L₁/D₁≥8.8, or L₁/D₁≥8.9 may be preferable, and L₁/D₁≥9.0, L₁/D₁≥9.1, L₁/D₁≥9.2, L₁/D₁≥9.3, L₁/D₁≥9.4, L₁/D₁≥9.5, L₁/D₁≥9.6, L₁/D₁≥9.7, L₁/D₁≥9.8, L₁/D₁≥9.9, or L₁/D₁≥10 may be more preferable. Alternatively, L₁/D₁≥10.5, L₁/D₁≥11, L₁/D₁≥11.5, or L₁/D₁≥12 may be preferable.

In the relational expression (2) L₂/D₂≤21, from the above viewpoint, L₂/D₂≤20.5, L₂/D₂≤20, L₂/D₂≤19.5, L₂/D₂≤19, L₂/D₂≤18.5, L₂/D₂≤18, L₂/D₂≤17.5, or L₂/D₂≤17 may be preferable. Alternatively, L₂/D₂≤16.5, L₂/D₂≤16, L₂/D₂≤15.5, L₂/D₂≤15, L₂/D₂≤14.5, L₂/D₂≤14, L₂/D₂≤13.5, L₂/D₂≤13, L₂/D₂≤12.5, or L₂/D₂≤12 may be preferable.

When each of the two or more ceramic filtration tubes 3 is formed in a cylindrical shape having approximately circular cross sections on the outer surface and the inner surface with each of the cross sections being constant totally from the second end portion to the first end portion (that is, in a case where the tube has the same outer diameter from the second end portion to the first end portion, and the tube has the same inner diameter from the second end portion to the first end portion), usually, the two or more filtration tubes 3 each have the same outer diameter and inner diameter, but may have different outer diameters and/or inner diameters in at least some of the filtration tubes. In such a case, the outer diameter D₁ and/or the inner diameter D₂ of the filtration tube 3 shall refer to an average value(s) of the outer diameters and/or the inner diameters of all of the two or more filtration tubes.

In a variant embodiment, at least part of the two or more ceramic filtration tubes 3 may have a circular cross section on the outer surface and/or the inner surface different from that at the second end portion, that is, may have an outer diameter and/or an inner diameter different from that at the second end portion, partially or almost entirely from the second end portion opposite to the molten metal discharging side to the first end portion. The proportion at which the outer diameter and/or the inner diameter of the filtration tube change(s) from the outer diameter and/or the inner diameter at the second end portion may be, for example, 20% or less, 15% or less, 10% or less, or 5% or less.

The outer diameter D₁ and/or the inner diameter D₂ in a case where the ceramic filtration tube 3 has an outer diameter and/or an inner diameter different from those at the second end portion as described above refer(s) to the outer diameter of the outer end surface 3a at the second end portion of the filtration tube and/or the inner diameter of the inner end surface 3b at the second end portion of the filtration tube. The definition by the average value(s) of the outer diameter D₁ and/or the inner diameter D₂ of the two or more filtration tubes 3 as described above is also applied to the case where at least part of the two or more filtration tubes has a circular cross section on the outer surface and the inner surface different from those at the second end portion partially or almost entirely from the second end portion to the first end portion.

In the embodiment where at least part of the two or more ceramic filtration tubes 3 has an outer diameter and/or an inner diameter different from that at the second end portion, partially or approximately entirely from the second end portion opposite to the molten metal discharging side to the first end portion, it is preferable that the inner diameter of the filtration tube is increased along the longitudinal direction from the second end portion to the first end portion in the relevant portion from the viewpoint of promoting the flow of the molten metal (purified metal) subjected to the filtration treatment of foreign matters to the molten metal discharging side. In other words, from the viewpoint of promoting the flow of the molten metal (purified metal) subjected to the filtration treatment of foreign matters to the molten metal discharging side, it is preferable that in at least part of the two or more ceramic filtration tubes 3, the inner diameter of the first end portion on the molten metal discharging side at the end surface 3w is larger than the inner diameter at the inner end surface 3b of the second end portion on the opposite side. With such a configuration, smooth flow of the purified metal to the discharging side is promoted, and the filtration efficiency of the molten metal can be further improved. Further, in at least a part of the plurality of ceramic filtration tubes 3, when the inner diameter of the first end portion on the molten metal discharging side at the end surface 3w is larger than the inner diameter of the second end portion on the opposite side at the inner end surface 3b, the outer diameter of the first end portion on the molten metal discharging side at the end surface 3w is more preferably substantially the same as the outer diameter of the second end portion on the opposite side at the outer end surface 3a. With such a configuration, the structural strength of the entire filtration unit can be kept good, the design of the recesses bored in the side plates can be facilitated, and the interval and arrangement of the two or more filtration tubes can be optimized to further improve the filtration efficiency.

Examples of the embodiment where the inner diameter of the first end portion on the molten metal discharging side at the end surface 3w is larger than the inner diameter at the inner end surface 3b at the second end portion on the opposite side in at least part of the two or more ceramic filtration tubes 3 include a structure in which the inner diameter continuously increases with a so-called reverse tapered inclination along the longitudinal direction partially or approximately entirely from the second end portion to the first end portion of the filtration tube, and a structure in which the inner diameter increases stepwise including some portions in which the inner diameter of the filtration tube is constant along the longitudinal direction from the second end portion to the first end portion. From the viewpoint of further promoting the flow of the molten metal (purified metal) subjected to the filtration treatment of foreign matters to the discharging side, the structure in which the inner diameter continuously increases with a so-called reverse tapered inclination along the longitudinal direction partially or approximately entirely from the second end portion to the first end portion of the filtration tube is preferable, and the structure in which the inner diameter continuously increases with a so-called reverse tapered inclination along the longitudinal direction entirely from the second end portion to the first end portion of the filtration tube is more preferable.

In the above-mentioned embodiments of the present invention including the variant embodiment, the length L₁ in the longitudinal direction of the portion exposed to the molten metal on the outer surface of the ceramic filtration tube 3, the outer diameter D₁ of the filtration tube 3, the length L₂ in the longitudinal direction of the portion exposed to the molten metal on the inner surface of the filtration tube 3, and the inner diameter D₂ of the filtration tube 3 are not particularly limited as long as the above relational expressions (1) and (2) are satisfied, but for example, these diameters may be in the following ranges.

The length L₁ in the longitudinal direction of the portion exposed to the molten metal on the outer surface of the filtration tube 3 may be, for example, usually 300 mm or more and 5000 mm or less, and preferably 400 mm or more and 4000 mm or less, 500 mm or more and 3000 mm or less, 600 mm or more and 2500 mm or less, 700 mm or more and 2000 mm or less, or 800 mm or more and 1500 mm or less.

The outer diameter D₁ of the filtration tube 3 may be, for example, usually 30 mm or more and 300 mm or less, preferably 40 mm or more and 250 mm or less, 50 mm or more and 200 mm or less, 60 mm or more and 150 mm or less, or 70 mm or more and 120 mm or less.

The longitudinal length L₂ of the exposed to the molten metal on the inner surface of the filtration tube 3 may be, for example, usually 400 mm or more and 5000 mm or less, and preferably 500 mm or more and 4000 mm or less, 600 mm or more and 3000 mm or less, 700 mm or more and 2000 mm or less, or 800 mm or more and 1500 mm or less.

The inner diameter D₂ of the filtration tube 3 may be, for example, usually 15 mm or more and 200 mm or less, preferably 20 mm or more and 150 mm or less, 25 mm or more and 100 mm or less, 30 mm or more and 90 mm or less, or 35 mm or more and 85 mm or less.

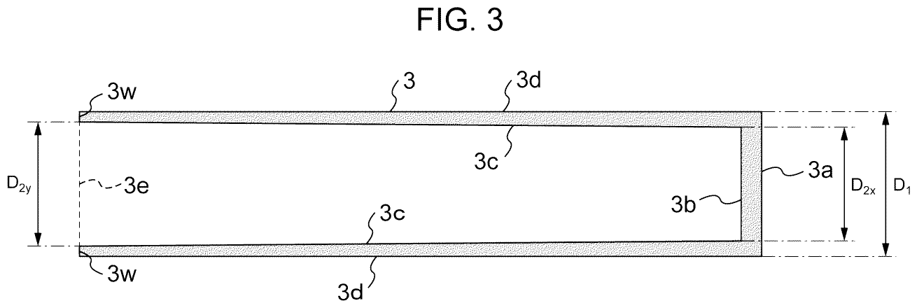

FIG. 3 illustrates, as a preferred example of the variant embodiment, a structure in which, throughout the ceramic filtration tube 3, the inner diameter at the end surface 3w of the first end portion on the molten metal discharging side is larger than the inner diameter at the inner end surface 3b of the second end portion on the opposite side, and the outer diameter at the end surface 3w of the first end portion on the side from which the molten metal is discharged is the same as the outer diameter at the outer end surface 3a of the second end portion on the opposite side. In the filtration tube 3 of this drawing, the inner diameter continuously increases with a constant inclination being a so-called reverse tapered inclination, along the longitudinal direction entirely from the second end portion to the first end portion. With such a structure of the ceramic filtration tube 3, it is possible to further promote smooth flow of the molten metal (purified metal) subjected to the filtration treatment of foreign matters to the molten metal discharging side.

In order to sufficiently filter the molten metal while promoting smooth flow of the molten metal (refined molten metal) that has been filtered of foreign matters to the discharging side, in at least part of the two or more ceramic filtration tubes 3, when the inner diameter at the end surface 3w of the first end portion on the molten metal discharging side is larger than the inner diameter at the inner end surface 3b of the second end portion on the opposite side, the inner diameter at the first end portion of the filtration tube may typically be 100.5% or more and 120% or less of the inner diameter at the second end portion. Preferably, the inner diameter at the first end portion of the filtration tube is 100.6% or more and 118% or less, 100.7% or more and 116% or less, 100.8% or more and 114% or less, 100.9% or more and 112% or less, 101% or more and 110% or less, 101.5% or more and 110% or less, 102% or more and 110% or less, 102.5% or more and 110% or less, or 103% or more and 110% or less of the inner diameter at the second end portion, from the viewpoint of further promoting smooth flow of the purified metal to the molten metal discharging side while sufficiently performing the filtration treatment of the molten metal, and further improving the filtration efficiency.

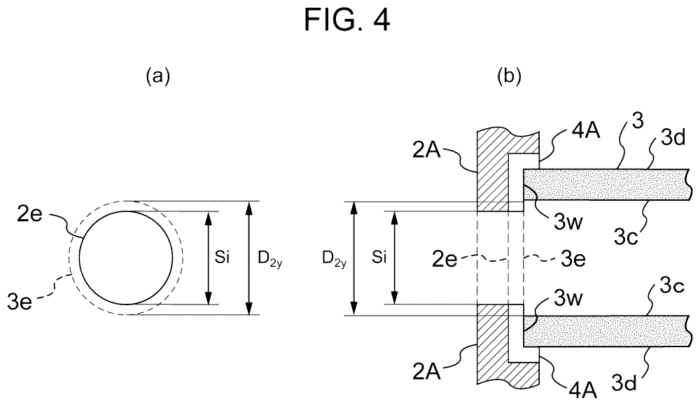

FIGS. 4(a) and 4(b) illustrate the relationship between an approximately circular opening 3e at the first end portion of the cylindrical ceramic filtration tube 3 on the side from which molten metal is dispensed, and an approximately circular through hole 2e made in the side plate 2A on the discharging side, in a molten metal filtration unit according to one embodiment. FIG. 4(a) is a cross-sectional view seen from the longitudinal direction, and FIG. 4(b) is a cross-sectional view seen from the horizontal direction perpendicular to the longitudinal direction.

Here, as illustrated in FIG. 4(b), the portion 3c exposed to the molten metal on the inner surface extending in the longitudinal direction of the cylindrical ceramic filtration tube 3 makes the approximately circular opening 3e at the edge of the first end portion on the side from which the molten metal is discharged. On the other hand, the approximately circular through hole 2e is made in the side plate 2A on the discharging side, and a recess having a shape surrounding the first end portion of the filtration tube 3 is bored at the peripheral edge of the through hole 2e in the end portion of the side plate 2A on the filtration tube arrangement side. The first end portion of the filtration tube 3 is fitted and fixed to the side plate 2A on the discharging side via the packing 4A so as to wrap both the annular end surface 3w at the first end portion of the filtration tube 3 on the discharge side of the molten metal and the annular periphery of the end of the portion 3d of the outer surface extending in the longitudinal direction of the filtration tube 3 that is exposed to the molten metal. In the embodiment illustrated in FIG. 4, the opening shape of the filtration tube arrangement side end of the approximately circular through hole 2e made in the side plate 2A on the discharging side is the same as the opening shape of the through hole 2e on the side opposite to the filtration tube arrangement side, that is, on the discharging side. As described above, in the embodiment of FIG. 4, the inner diameter of the end on the discharging side of the approximately circular through hole 2e of the side plate 2A of the discharging side is equal to an inner diameter Sᵢ of the end of the through hole 2e of the side plate 2A on the filtration tube arrangement side.

In this embodiment, as illustrated in FIG. 4(a) together with FIG. 4(b), the shape of the opening 3e at the first end portion of the ceramic filtration tube 3 on the molten metal discharging side includes (contains) the opening shape of the filtration tube arrangement side end of the approximately circular through hole 2e made in the side plate 2A on the molten metal discharging side as viewed in the longitudinal direction. That is, a diameter D_{2y} of the opening 3e at the first end portion on the side of the ceramic filtration tube 3 from which the molten metal is discharged (i.e., the inner diameter at the first end portion of the filtration tube 3) is larger than the inner diameter Sᵢ of the filtration tube arrangement side end of the through hole 2e of the side plate 2A. In other words, the inner diameter Sᵢ of the filtration tube arrangement side end of the through hole 2e of the side plate 2A is smaller than the diameter D_{2y} of the approximately circular opening 3e made at the first end portion of the filtration tube 3 on the side from which the molten metal is discharged. In this embodiment, the ratio of Sᵢ to D_{2y} ([Sᵢ/D_{2y}]×100(%)) is not particularly limited as long as the relationship Sᵢ<D_{2y} is fulfilled, but the ratio may be usually 80% or more and less than 100%, and preferably 85% or more and less than 100%, 90% or more and less than 100%, 95% or more and less than 100%, 98% or more and less than 100%, 99% or more and less than 100%, 99.5% or more and less than 100%, or 99.9% or more and less than 100%.

As described above, by making a structure in which the inner diameter Sᵢ of the filtration tube arrangement side end of the through hole 2e of the side plate 2A is smaller than the diameter D_{2y} of the opening 3e at the first end portion of the filtration tube 3 on the side where the molten metal is discharged, the inner surface edge portion of the first end portion of the filtration tube 3 is not exposed to the molten metal, so that deterioration and wear-out of the filtration tube 3 at the relevant portion can be effectively suppressed, and the life of the filtration tube can be further extended.

In the embodiment of FIG. 4, in a case where the approximately circular cross-sectional shape of the opening 3e at the first end portion of the filtration tube 3 and/or the through hole 2e of the side plate 2A is not a perfect circular shape, D_{2y} and/or Sᵢ shall be determined by a circumscribed circle of the cross-sectional shape.

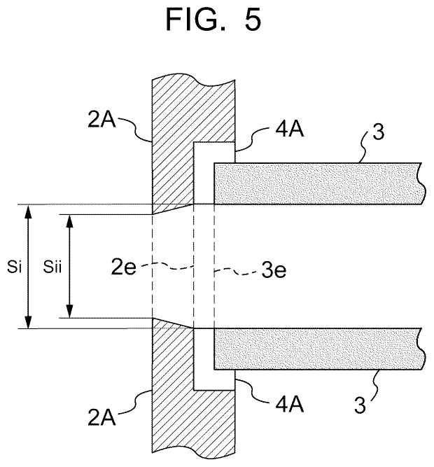

In the approximately circular through hole 2e made in the side plate 2A on the side from which the molten metal is discharged in the molten metal filtration unit according to one embodiment, the cross-sectional view of FIG. 5 illustrates the relationship between the inner diameter Sᵢ of the end of the through hole 2e on the side where the ceramic filtration tube 3 is disposed (that is, the side where the packing 4A is disposed in this drawing) and the inner diameter Sᵢᵢ of the end of the through hole 2e on the molten metal discharging side. As illustrated in the drawing, in the present embodiment, in the approximately circular through hole 2e made in the side plate 2A on the side from which the molten metal is discharged, the inner diameter Sᵢᵢ of the end on the discharge side is formed to be smaller than the inner diameter Sᵢ of the end on the side on which the filtration tube 3 is disposed. As means for making the inner diameter Sᵢᵢ of the end of the through hole 2e on the discharging side smaller than the inner diameter Sᵢ of the end of the through hole 2e on the side where the filtration tube 3 is disposed, an inclination (tapered shape) of a constant angle or a changing angle may be given as illustrated, or alternatively, one or two or more stair-like steps may be made.

In the embodiment of FIG. 5, the ratio of Sᵢᵢ to Sᵢ ([Sᵢᵢ/Sᵢ]×100(%)) is not particularly limited as long as the relationship Sᵢ>Sᵢᵢ is fulfilled, but the ratio may be usually 80% or more and 99.5% or less, and preferably 83% or more and 99.4% or less, 85% or more and 99.3% or less, 87% or more and 99.2% or less, 89% or more and 99.1% or less, 90% or more and 99% or less, 91% or more and 99% or less, or 92% or more and 99% or less.

As described above, in the approximately circular through hole 2e made in the side plate 2A on the side from which the molten metal is discharged, when the inner diameter Sᵢᵢ of the end of the through hole 2e on the discharging side is smaller than the inner diameter Sᵢ of the end of the through hole 2e on the side on which the filtration tube 3 is disposed, the molten metal can be prevented from being discharged from the filtration unit in a state where the filtration treatment of the foreign matters is insufficient, and the possibility that the foreign matters are contained in the purified metal after the filtration treatment can be further made smaller.

In the present specification, any two or more of the embodiments described so far can be combined with each other, and if further desired, it can be combined with any of the embodiments described later.

For example, the embodiment illustrated in FIG. 3 (i.e., the embodiment where, in at least part of the two or more ceramic filtration tubes 3, the inner diameter of the first end portion on the molten metal discharging side at the end surface 3w is larger than the inner diameter of the second end portion on the opposite side at the inner end surface 3b) can be combined with the embodiment illustrated in FIG. 4 (i.e., the embodiment where the shape of the opening 3e at the first end portion of the ceramic filtration tube 3 on the side from which the molten metal is discharged includes or contains the opening shape of the filtration tube arrangement side end of the approximately circular through hole 2e made in the side plate 2A on the molten metal discharge side as viewed in the longitudinal direction).

Alternatively, the embodiment illustrated in FIG. 3 can be combined with the embodiment illustrated in FIG. 5 (i.e., the embodiment where the inner diameter Sᵢᵢ of the end on the discharging side of the approximately circular through hole 2e made in the side plate 2A on the side from which the molten metal is discharged is smaller than the inner diameter Sᵢ of the end of the through hole 2e on the side on which the filtration tube 3 is disposed).

Alternatively, the embodiment illustrated in FIG. 4 can be combined with the embodiment illustrated in FIG. 5.

Alternatively, the three embodiments illustrated in FIGS. 3, 4, and 5 can be combined with one another.

The above-described advantages obtained by each of these embodiments can be equally additively exhibited in the combinations of these embodiments and are not abated or offset.

A particularly preferred variant embodiment is an embodiment modified to combine the three embodiments illustrated in FIGS. 3, 4, and 5, that is, <1> the embodiment of FIG. 3 in which, in at least part of the two or more ceramic filtration tubes 3, the inner diameter of the first end portion on the molten metal discharging side at the end surface 3w is larger than the inner diameter of the second end portion on the opposite side at the inner end surface 3b; <2> the embodiment of FIG. 4 in which the shape of the opening 3e at the first end portion of the ceramic filtration tube 3 on the side where the molten metal is discharged includes or contains, as viewed in the longitudinal direction, the opening shape of the filtration tube arrangement side end of the approximately circular through hole 2e made in the side plate 2A on the discharging side; and <3> the embodiment of FIG. 5 in which, in the approximately circular through hole 2e made in the side plate 2A on the side where the molten metal is discharged, the inner diameter Sᵢᵢ of the end of the through hole on the discharge side is smaller than the inner diameter Sᵢ of the end of the through hole on the side where the filtration tube 3 is disposed.

This variant embodiment can result in all of the advantages described above for each embodiment. That is, according to such an embodiment, it is possible to further promote smooth flow of the molten metal (purified metal) subjected to the filtration treatment of foreign matters to the discharging side; and in addition, it is possible to effectively suppress deterioration and wear-out of the filtration tube at the inner edge portion of the first end portion of the filtration tube, which can further extend the life of the filtration tube; and in addition, it is possible to suppress the molten metal from being discharged from the filtration unit in a state where the filtration treatment of foreign matters is insufficient, and to further reduce the possibility of containing foreign matters in the purified metal subjected to the filtration treatment.

In a preferred embodiment, at least part of the two or more ceramic filtration tubes 3 of the molten metal filtration unit 1 may be formed of a porous material having a porosity of typically 25% to 50%. By forming the filtration tube 3 with a porous material having a porosity in such a range, it is possible to optimize the balance between the removal and filtration performance of foreign matters in the molten metal by the filtration tube and the extension of the life of the filtration tubes (i.e., the suppression of a decrease in filtration performance in a short period of time), and eventually to improve the filtration efficiency. The porosity of the porous material forming the filtration tube may be preferably 25% or more and 45% or less, 28% or more and 42% or less, or 30% or more and 40% or less from the above viewpoint.

In the embodiment in which the ceramic filtration tube 3 is formed of a porous material having a porosity in the above range, examples of the aggregate constituting the porous material include, but are not limited to, one or more kinds of alumina such as silicon carbide, fused alumina, and sintered alumina. The aggregate constituting the porous material may be preferably one or more kinds of alumina such as fused alumina and sintered alumina.

The average particle diameter of the aggregate constituting the porous material of the ceramic filtration tube 3 is not particularly limited, but may be usually 200 μm or more and 2500 μm or less from the viewpoint of controlling the porosity within the above range. The average particle diameter of the aggregate of the ceramic filtration tube 3 may be preferably 250 μm or more and 2000 μm or less, and more preferably 500 μm or more and 1700 μm or less.

Here, the “average particle diameter” of the aggregate constituting the porous material of the filtration tube is a value obtained by imaging a scanning electron microscope (SEM) image of a cross section perpendicular to the longitudinal direction of the filtration tube, measuring the particle diameters of the aggregate from the SEM image by an intercept method, and obtaining an average thereof. Specifically, an arbitrary line is drawn on the SEM image of the cross section of the filtration tube, and the major axes and the minor axes of the aggregate particles intersecting the line are measured. Next, the particle shape is defined as an ellipse, and the average value of the major axis and the minor axis is defined as the particle diameter for each of the aggregate particles. Then, a plurality of SEM images of different fields of view is imaged, the above-described measurement is repeated using the plurality of imaged SEM images, the particle diameters of 500 or more aggregates are measured, and then statistically processed to determine the average particle diameter of the aggregate in the cross-sectional structure of the filtration tube. In addition, the “porosity” of the above-described filtration tube may be calculated as a ratio of an actual density calculated based on a dimension and a mass of the filtration tube to a theoretical density of the filtration tube (for example, one formed from a ceramic material such as silicon carbide or alumina as a main raw material and a small amount of an inorganic binder).

Examples of materials constituting parts other than the ceramic filtration tube 3 of the molten metal filtration unit 1 will be each described below.

The adhering portions of the packing 4A and the packing 4B of the molten metal filtration unit 1, which are flat plate-shaped bodies in contact with each end surface of the filtration tube 3, may be formed of, for example, a ceramic fiber material such as an alumina fiber or a ceramic fiber, specifically, a reaction product of basic aluminum chloride and silica, or the like. In addition, the sealing portions which are annular bodies in contact with the edge portions of the outer surface of the filtration tube 3 in the packing 4A and the packing 4B may be formed of, for example, a fiber-based material, typically, an alumina-silica ceramic fiber containing an inorganic binder. In a structure of the packing in which the adhering portion and the sealing portion are integrally formed, these portions may be formed of any of the above-described materials.

Next, an outline of a non-limiting example of a method for manufacturing the ceramic filtration tube 3 constituting the molten metal filtration unit 1 will be described.

The method for manufacturing the ceramic filtration tube 3 may include the steps of kneading, molding, drying, degreasing, and sintering.

The kneading step is, for example, a process of kneading a mixture containing the above-described raw material particles of aggregate and the inorganic binder to prepare a kneaded material. Specifically, it can be obtained by kneading a mixture that contains the aggregate particles, the inorganic binder, an organic binder, and water and constitutes the raw material of the ceramic filtration tube 3 using, for example, a kneading device such as a mixing stirrer.

As the aggregate particles, for example, those of the above-described materials can be used. As the inorganic binder, for example, one or more of boron trioxide, alumina, magnesium oxide, and silica can be used. Among them, when boron trioxide and alumina are used as the inorganic binder, a part thereof may react by sintering to form needle-like crystals of 9Al₂O₃·2B₂O₃.

As the organic binder, for example, one or more of starch-based, cellulose-based, and polysaccharide-based organic binders can be used. As the water, deionized water or distilled water containing less impurities can be suitably used. In order to appropriately sinter the aggregate particles, a sintering aid may be further added and kneaded. In addition, optional various additives such as an organic pore-forming agent, a lubricant, a plasticizer, and a mold release agent may be added and kneaded as necessary.

The molding step is a process of filling the kneaded material obtained by the kneading step in a mold prepared in advance and molding the kneaded material. The drying step subsequently performed is a process of drying the molded body obtained by the molding step. Through such a drying step, moisture is removed from the molded body.

The degreasing step is a process of removing an organic component such as an organic binder from the molded body from which moisture has been removed by the drying step. When the molded body is exposed to various conditions such as predetermined temperature and time, organic components contained in the molded body can be decomposed and removed. In addition, in a case where the organic pore-forming agent is removed, pores corresponding to the shape of the organic pore-forming agent can be generated.

The sintering step is a process of sintering the molded body from which the organic component has been removed by the degreasing step with a sintering device. The sintered body obtained by sintering can be subjected to a processing treatment or the like of the end portions as necessary, thereby obtaining the ceramic filtration tube 3.

### <Additional Embodiments Regarding Structure of Side Plates>

The structure of the pair of side plates themselves included in the molten metal filtration unit according to the present invention is not particularly limited except that it is specified in the appended claims. These two side plates may satisfy specific relationships with respect to an original and devised shape or dimension as exemplified in the following items (1) to (3), in addition to a form in which each of the two side plates has substantially the same outer shape which is an approximately rectangular parallelepiped plate shape.

### (1). Additional Embodiment 1 of Molten Metal Filtration Unit

As an additional example of the molten metal filtration unit, there is one including a pair of side plates specified as follows.

A molten metal filtration unit, comprising:
a pair of side plates; and
an approximately cylindrical filtration tube(s) connected approximately vertically to the pair of side plates, in which
the pair of side plates comprises
a first side plate having a through hole at a position connected to the filtration tube, and
a second side plate closed at a position connected to the filtration tube, and
when a longitudinal direction of the filtration tube is approximately horizontal, the first side plate is located on a left side of the filtration tube, and the second side plate is located on a right side of the filtration tube,
at least one of the pair of side plates has a bottom portion formed such that one of a left bottom side and a right bottom side is higher in a vertical direction than the other bottom side.

The molten metal filtration unit according to this additional embodiment may further be configured according to the following non-limiting sub-embodiments.

(i)

In a case where the longitudinal direction of the filtration tube is approximately horizontal, the first side plate is located on the left side of the filtration tube, and the second side plate is located on the right side of the filtration tube,
the first side plate has a bottom portion formed such that one of a left bottom side and a right bottom side is positioned higher than the other bottom side in the vertical direction,
in a case where the first side plate has a bottom portion formed such that the left bottom side is positioned higher than the right bottom side in the vertical direction, the second side plate has a bottom portion formed such that the left bottom side is positioned higher than the right bottom side in the vertical direction, or
in a case where the first side plate has a bottom portion formed such that the right bottom side is positioned higher than the left bottom side in the vertical direction, the second side plate has a bottom portion formed such that the right bottom side is positioned higher than the left bottom side in the vertical direction.
   (ii)

In a case where the longitudinal direction of the filtration tube is approximately horizontal, the first side plate is located on the left side of the filtration tube, and the second side plate is located on the right side of the filtration tube,
at least one of the pair of side plates has a stepped portion formed such that one of a left bottom side and a right bottom side is located higher than the other bottom side in the vertical direction.
   (iii)

In the embodiment of the item (ii), in a case where the longitudinal direction of the filtration tube is approximately horizontal, the first side plate is located on the left side of the filtration tube, and the second side plate is located on the right side of the filtration tube,
the pair of side plates have a stepped portion formed in such a manner that the left side bottom side is positioned vertically higher than the right side bottom side.
   (iv)

In the embodiment of the item (ii), in a case where the longitudinal direction of the filtration tube is approximately horizontal, the first side plate is located on the left side of the filtration tube, and the second side plate is located on the right side of the filtration tube,
the stepped portion includes a first bottom portion as the lowest part and a second bottom portion formed to be higher than the first bottom portion in the vertical direction, and
a ratio (W1/W2) of a horizontal length W1 of the first bottom portion to a horizontal length W2 of the second bottom portion is 0.1 or more and 6.0 or less, provided that W1 and W2 are lengths in a direction parallel to the longitudinal direction of the filtration tube.
   (v)

In the embodiment of the item (ii), in a case where the longitudinal direction of the filtration tube is approximately horizontal, the first side plate is located on the left side of the filtration tube, and the second side plate is located on the right side of the filtration tube,
the stepped portion includes a first bottom portion which is the lowest part, and a second bottom portion which is formed to be located vertically higher than the first bottom portion,
a ratio (W1/H2) of a horizontal length W1 of the first bottom portion to a vertical length H2 from the first bottom portion to the second bottom portion is 0.1 or more and 11 or less, where W1 is the length in the direction parallel to the longitudinal direction of the filtration tube.
   (vi)

In a case where the longitudinal direction of the filtration tube is approximately horizontal, the first side plate is located on the left side of the filtration tube, and the second side plate is located on the right side of the filtration tube,
at least one of the pair of side plates is formed in such a manner that either the left bottom side or the right bottom side is located vertically higher than the other bottom portion, and has a bottom portion including a first bottom portion which is the lowest part, and an inclined portion connecting from the first bottom portion to the bottom side which is located vertically higher than the first bottom portion.
   (vii)

In the embodiment of the item (vi), in a case where the longitudinal direction of the filtration tube is approximately horizontal, the first side plate is located on the left side of the filtration tube, and the second side plate is located on the right side of the filtration tube,
a ratio (W1′/W2′) of a horizontal length W1′ of the first bottom portion to a horizontal length W2′ of the inclined portion is 0 or more and 6.0 or less, where W1′ and W2′ are lengths parallel to the longitudinal direction of the filtration tube.
   (viii)

In the embodiment of the item (vi), in a case where the longitudinal direction of the filtration tube is approximately horizontal, the first side plate is located on the left side of the filtration tube, and the second side plate is located on the right side of the filtration tube,
a ratio (W1′/H2′) of a horizontal length W1′ of the first bottom portion to a vertical length H2′ from the end portion of the inclined portion that contacts the first bottom portion to the other end portion of the inclined portion is 0 or more and 320 or less, where W1′ is the length in the direction parallel to the longitudinal direction of the filtration tube.
   (ix)

In the embodiment of the item (viii), in a case where the longitudinal direction of the filtration tube is approximately horizontal, the first side plate is located on the left side of the filtration tube, and the second side plate is located on the right side of the filtration tube,
an angle θ1 between the inclined portion and the vertical direction is 60° or more and 89° or less.
   (x)

In the embodiment of the item (vi), in a case where the longitudinal direction of the filtration tube is approximately horizontal, the first side plate is located on the left side of the filtration tube, and the second side plate is located on the right side of the filtration tube,
the pair of side plates are formed in such a manner that the left bottom side is located vertically higher than the right bottom side, and are provided with a first bottom portion which is the lowest part, and a bottom portion having an inclined portion connecting the first bottom portion to the left bottom side.
   (xi)

In the embodiment of the item (vi), in a case where the longitudinal direction of the filtration tube is approximately horizontal, the first side plate is located on the left side of the filtration tube, and the second side plate is located on the right side of the filtration tube,
the pair of side plates is formed in such a manner that the right bottom side is located vertically higher than the left bottom side, and has a bottom portion including a first bottom portion which is the lowest part, and an inclined portion connecting the first bottom portion to the right bottom side.
   (xii)

A molten metal filtration apparatus having a molten metal discharging port, in which
the molten metal filtration unit according to the embodiment of the item (ix), in which the pair of side plates includes an inclined portion where a right bottom side is located higher than a left bottom side in a vertical direction under the condition that a longitudinal direction of the filtration tube is approximately horizontal, the first side plate is located on a left side of the filtration tube, and the second side plate is located on a right side of the filtration tube, is disposed in such a manner that the first side plate is in contact with the discharging port, and
the filtration apparatus includes, on a hearth, a wedge-shaped projection having an angle θ2 formed by a surface in contact with the molten metal filtration unit and a horizontal plane, and θ2 is an angle satisfying the relationship that a sum of θ1 and θ2 is 61° or more and 114° or less.

### (2). Additional Embodiment 2 of Molten Metal Filtration Unit

As an additional example of the molten metal filtration unit, there is one including a pair of side plates specified as follows.

A molten metal filtration unit comprising:
a pair of side plates; and
an approximately cylindrical filtration tube(s) connected approximately vertically to each of the pair of side plates, in which
the pair of side plates comprises
a first side plate having a through hole at a point connected to the filtration tube, and
a second side plate closed at a point connected to the filtration tube,
each side plate has at least one leg portion hanging from the bottom surface of the side plate,
in a case where the longitudinal direction of the filtration tube is approximately horizontal, the lowest vertical position of the leg portion of the second side plate is lower than the lowest vertical position of the leg portion of the first side plate.

The molten metal filtration unit according to this additional embodiment may further be configured according to the following non-limiting sub-embodiments.

(i)

In a case where the longitudinal direction of the filtration tube is approximately horizontal, a ratio of the length in the vertical direction of the leg portion of the first side plate to the length in the vertical direction of the leg portion of the second side plate is 0.20 or more and less than 1.0.

(ii)

The total ground contact area of all the leg portions in the molten metal filtration unit is 0.015 or more and 0.075 or less relative to the total bottom area of the pair of side plates.

(iii)

In the embodiment of the item (ii), the total ground contact area of all the leg portions in the molten metal filtration unit is 0.020 or more and 0.060 or less relative to the total bottom area of the pair of side plates.

(iv)

At least, the first side plate has two leg portions, and the second side plate has one leg portion.

(v)

In the embodiment of the item (iv), at least, two leg portions are arranged in the vicinity of both ends in the longitudinal direction of the bottom surface of the first side plate, and one leg portion is arranged at a substantially central position in the longitudinal direction of the bottom surface of the second side plate.

### (3). Additional Embodiment 3 of Molten Metal Filtration Unit

As an additional example of the molten metal filtration unit, there is one including a pair of side plates specified as follows.

A molten metal filtration unit comprising:
a pair of side plates; and
an approximately cylindrical filtration tube(s) connected approximately perpendicularly to each of the pair of side plates, in which
the pair of side plates comprises
a first side plate having a through hole at a point connected to the filtration tube, and
a second side plate closed at a point connected to the filtration tube,
each side plate has a leg portion(s) hanging from the bottom surface of the side plate, and
the number of leg portion(s) arranged on the first side plate is at least one more than the number of leg portion(s) arranged on the second side plate.

The molten metal filtration unit according to this additional embodiment may further be configured according to the following non-limiting sub-embodiments.

(i)

The first side plate has two leg portions and the second side plate has one leg portion.

(ii)

Two leg portions are arranged in the vicinity of both ends in the longitudinal direction of the bottom surface of the first side plate, and one leg portion is arranged at a substantially central position in the longitudinal direction of the bottom surface of the second side plate.

(iii)

In a case where the molten metal filtration unit is placed on a horizontal plane and seen from vertically above, an area of the molten metal filtration unit calculated as a product of a length of the molten metal filtration unit in the longitudinal direction of the filtration tube and a length of the side plate in the longitudinal direction is defined as S1,
a total area of ground contact areas of all leg portions of the molten metal filtration unit is defined as S2, and
an area ratio S2/S1 is 0.0020 or more and 0.015 or less.

### EXAMPLES

Hereinafter, the present invention will be described more specifically with reference to examples.

These examples are not intended to limit the invention in any way and are to be understood as illustrative only.

### Production Example 1 of Ceramic Filtration Tube

10 parts by mass of an inorganic binder was kneaded with 100 parts by mass of fused alumina (“aggregate particles”) having an average particle diameter of 600 μm. As the inorganic binder, a material containing the following compounds was used: 45 mass % of boron trioxide, 20 mass % of alumina, 20 mass % of magnesium oxide, 10 mass % of silica, 0.01 mass % of Na₂O, 0.01 mass % of K₂O₃, and 0.2 mass % of CaO. Next, the kneaded material containing the fused alumina and the inorganic binder was used to prepare a cylindrical molded body in which a cross-sectional shape perpendicular to the longitudinal direction on each of the outer surface and the inner surface was circular, one end portion (first end portion) was opened, and the other end portion (second end portion) was closed. This molded body was dried at 80 °C for 8 hours, and then subjected to a degreasing treatment at 900 °C for 6 hours. Thereafter, the dried and degreased molded body was sintered at 1250 °C for 7 hours in a firing furnace to produce a ceramic filtration tube. In preparing the cylindrical molded body, the sizes of the molded body were adjusted so that the length L₁ in the longitudinal direction of the portion exposed to the molten metal on the outer surface of the filtration tube was 900 mm, the outer diameter D₁ of the filtration tube was 100 mm, the length L₂ in the longitudinal direction of the portion exposed to the molten metal on the inner surface of the filtration tube was 930 mm, and the inner diameter D₂ of the filtration tube was 60 mm. The outer diameter D₁ and the inner diameter D₂ of the filtration tube were constant throughout the longitudinal direction. The aggregate of the filtration tube had an average particle size of 600 μm and a porosity of 38% (the same applies to the following production examples). The average particle size and the porosity were measured according to the methods described above.

### Production Example 2 of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 1000 mm, the outer diameter D₁ of the filtration tube was 100 mm, the longitudinal length L₂ of the part of the inner surface of the filtration tube exposed to the molten metal was 1030 mm, and the inner diameter D₂ of the filtration tube was 60 mm.

### Production Example 3 of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 1200 mm, the outer diameter D₁ of the filtration tube was 100 mm, the longitudinal length L₂ of the part of the inner surface of the filtration tube exposed to the molten metal was 1230 mm, and the inner diameter D₂ of the filtration tube was 60 mm.

### Production Example 4 of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 1000 mm, the outer diameter D₁ of the filtration tube was 100 mm, the longitudinal length L₂ of the part of the inner surface of the filtration tube exposed to the molten metal was 1030 mm, and the inner diameter D₂ of the filtration tube was 50 mm.

### Production Example 5 of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 1000 mm, the outer diameter D₁ of the filtration tube was 100 mm, the longitudinal length L₂ of the part of the inner surface of the filtration tube exposed to the molten metal was 1030 mm, and the inner diameter D₂ of the filtration tube was 70 mm.

### Production Example 1C of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 800 mm, the outer diameter D₁ of the filtration tube was 100 mm, the longitudinal length L₂ of the part of the inner surface of the filtration tube exposed to the molten metal was 830 mm, and the inner diameter D₂ of the filtration tube was 60 mm.

### Production Example 2C of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 820 mm, the outer diameter D₁ of the filtration tube was 80 mm, the longitudinal length L₂ of the part of the inner surface of the filtration tube exposed to the molten metal was 850 mm, and the inner diameter D₂ of the filtration tube was 40 mm.

### Production Example 3C of Ceramic Filtration Tube

In preparing the above cylindrical molded body, a ceramic filtration tube was produced in the same manner as in Production Example 1 mentioned above except that the sizes of the molded body were adjusted so that the longitudinal length L₁ of the part of the outer surface of the filtration tube exposed to the molten metal was 820 mm, the outer diameter D₁ of the filtration tube was 100 mm, the longitudinal length L₂ of the part of the inner surface of the filtration tube exposed to the molten metal was 850 mm, and the inner diameter D₂ of the filtration tube was 60 mm.

### Production of Molten Metal Filtration Unit

### Example 1

Two side plates formed of a material containing silicon carbide as a main component were prepared. Each side plate was a flat plate-shaped body having a thickness of 60 mm, a length of 700 mm, and a width of 720 mm. In one side plate placed on the side from which the molten metal is discharged, three sets of six 60 mm circular through holes (i.e., the holes with the equal inner diameter at the end of the side plate where the filtration tube is installed and at the opposite end where the molten metal is discharged) made horizontally, and two sets of five of the same size through holes made horizontally were alternately arranged so that the spacing between each through hole was 55 mm, and the total number of these through holes was 28. Such through holes were not made in the side plate placed on the opposite side to the side from which the molten metal was discharged. In addition, each side plate was formed to have peripheral wall surfaces having a circular cross section conforming to the shape (outer diameter) of each end portion of the filtration tubes and recesses with a flat bottom surface. The depth of each recess with respect to the length-height surface of the side plate (i.e., the depth in the direction corresponding to the longitudinal direction of the filtration tube) was set to 31.3 mm. In the one side plate placed on the side from which the molten metal is discharged, each of the through holes was disposed at the center of each recess.

Packings made of alumina fiber having a circular opening with a diameter of 60 mm, a shape conforming to the bottom surface of the recess, and a thickness of 6 mm, and packings having a similar structure except that the circular opening was not made were prepared. The packing having the circular opening was disposed in each recess of the side plate placed on the molten metal discharging side with the through holes, and the packing having no circular opening was disposed in each recess of the side plate having no through holes. Then, the first end portion of the ceramic filtration tube of Production Example 1 having the opening on the molten metal discharging side was fitted and fixed to each recess of the side plate placed on the molten metal discharging side with the through holes and the packing having the circular opening corresponding thereto, and the closed second end portion of the filtration tube was fitted and fixed to each recess of the side plate having no through holes and the packing having no circular opening corresponding thereto. In order to prevent leakage of the molten metal, the packing was compressed so as to have a thickness of 3 mm, which was 50% of the original thickness, by pressing from both sides of the side plates thereby obtaining a molten metal filtration unit of Example 1.

### Examples 2 to 5 and Examples 1C to 3C

Molten metal filtration units of Examples 2 to 5 and Examples 1C to 3C were obtained in the same manner as in Example 1 except that each of the ceramic filtration tubes of Production Example 2 to 5 and Production Examples 1C to 3C was used instead of the ceramic filtration tube of Production Example 1, and a side plate with through holes having a size corresponding to the inner diameter of each filtration tube and packings with an opening having a size corresponding thereto were used.

### Evaluation of Filtration Performance

The following measurement and evaluation of (1) and (2) were performed on each of the molten metal filtration units of Examples 1 to 5 and Examples 1C to 3C obtained above. The results are shown in Table 1 below together with the structural factors of the ceramic filtration tubes of these units.

### (1) Measurement of Head Height Change of Molten Metal in Filtration Chamber

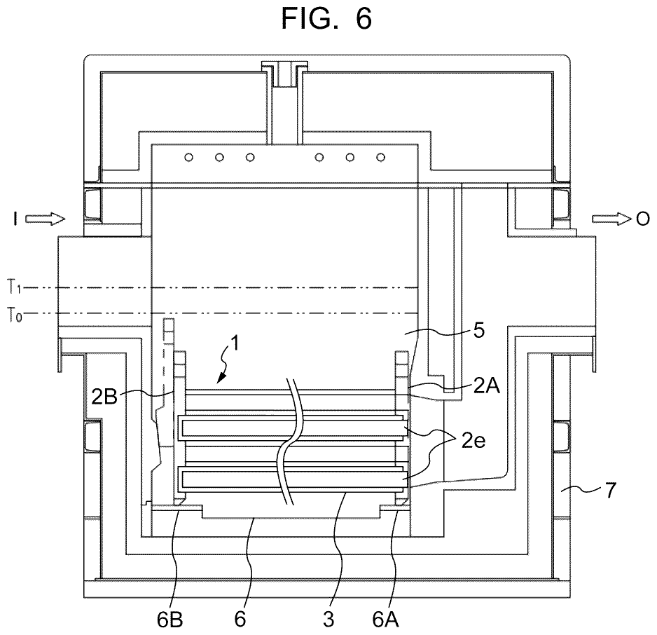

The molten metal filtration unit was placed on a hearth of a filtration chamber having an entrance port and a discharging port of molten metal, a predetermined amount of molten metal of aluminum (720 °C) was supplied to the filtration tubes of the molten metal filtration unit through the entrance port, and an amount of change of a liquid level of the molten aluminum (hereinafter, also referred to as a “head height”) in the filtration chamber was measured. Specifically, the height T₀ of the molten metal head in the filtration chamber at the start of filtration was measured, and the height T₁ of the molten metal head after 40 tons (t) of the molten metal passed per one of the filtration tubes was measured (see FIG. 6 for reference). In this measurement test, the flow rate of the molten metal per one filtration tube was set to 16 kg/min (about 950 kg/hour). In FIG. 6 attached for reference, reference sign 1 denotes a molten metal filtration unit, reference sign 2A denotes a side plate placed on the molten metal discharging side, reference sign 2B denotes a side plate placed on the entrance side, reference sign 2e denotes through holes made in the side plate placed on the discharging side, reference sign 3 denotes ceramic filtration tubes, reference sign 5 denotes a filtration chamber, reference sign 6 denotes a filtration bed, reference signs 6A and 6B each denote a pedestal formed on the hearth, reference sign 7 denotes a housing of the filtration chamber, reference sign I denotes an entrance port of the molten metal to the filtration chamber, reference sign O denotes a discharging port of the molten metal from the filtration chamber, reference sign T₀ denotes a molten metal head height in the filtration chamber at the start of filtration, and reference sign T₁ denotes a molten metal head height after passing 40 tons of molten metal per one filtration tube.

The lower the amount of change (value of T₁-T₀) in the molten metal head height in the filtration chamber, the lower the filtration resistance when the molten metal was continuously flown, which means that the molten metal filtration could be more stably performed. Therefore, the stability of filtration was evaluated by the following three grades based on the amount of change in the height of the molten metal head in the filtration chamber. The amounts of change in the head height (mm) accompanied by the score in the parenthesis for each example are shown in Table 1.
3 points: The change in the molten metal head height was <50 mm.
2 points: The change in the molten metal head height was between 50 mm and 100 mm.
1 point: The change in the molten metal head height was >100 mm.

### (2) Measurement of Amount of Molten Metal Passing Until Predetermined Head Height Change is Reached (Evaluation of Life of Ceramic Filtration Tubes)

When the flow path through which a molten metal passes is made smaller by inclusions being trapped in a ceramic filtration tube, the height of the molten metal head in the filtration chamber increases over time. In general, a molten metal is subjected to filtration under natural flow down. When a molten metal is subjected to a filtration treatment with a clogged filtration tube, a head height for generating a sufficient pressure for the flow of the molten metal is required. However, when the head height increases, a risk that the molten metal overflows from the tank of the filtration chamber and a decrease in the filtration speed may arise. In this test, the life of the filtration tube was evaluated by measuring the amount of molten metal passing (ton/tube) until the change in height of the molten metal head before and after filtration reached 120 mm. In this test, the measurement test of the molten metal head height in the item (1) mentioned above was continuously performed, and the amount of molten metal passing (ton/tube) when the final amount of change in the molten metal head height (i.e., the value of T₁−T₀) reached 120 mm was calculated. In this test, the life of the filtration tube was evaluated according to the amount of molten metal passing in the following three grades. The amounts of molten metal passing (ton/tube) accompanied by the score in the parenthesis for each example are shown in Table 1.
3 points: The amount of molten metal passing until the change in height of the molten metal head reached 120 mm was >60 tons/tube (i.e., more than 60 tons per filtration tube).
2 points: The amount of molten metal passing until the change in height of the molten metal head reached 120 mm was from 50 tons/tube to 60 tons/tube (i.e., the amount of molten metal passing through one filtration tube until the change in height of the molten metal head reached 120 mm was 50 tons or more and 60 tons or less).
1 point: The amount of molten metal passing until the change in head height of the molten metal reached 120 mm was <50 tons/unit (i.e., less than 50 tons per filtration tube).

### (3) Comprehensive Evaluation of Filtration Performance of Ceramic Filtration Tubes

The filtration performance of the ceramic filtration tube was comprehensively evaluated based on the total score of the test results of the above items (1) and (2). In the examples where the evaluation A and the evaluation B were obtained, even when the filtration amount of the molten metal increased, the head height at the time of passing the molten metal was low, the molten metal could be stably filtered, and the filtration life was long, which was preferred. On the other hand, in the examples where the evaluation C was obtained, because the head height was made higher as the filtration amount of the molten metal increased, there were concerns about overflow of the molten metal from the tank of the filtration chamber and total reduction of the filtration amount, which was not considered to be appropriate for operation. The evaluations accompanied by the total score in the parenthesis for each example are shown in Table 1.
Evaluation A: 6 points
Evaluation B: 4 to 5 points
Evaluation C: 3 points or less

TABLE 1
Structures of Ceramic Filtration Tubes and Evaluation Results of Filtration Performance

| | Ex. 1 | Ex. 2 | Ex. 3 | Ex. 4 | Ex. 5 |
|---|---|---|---|---|---|
| Exposed length of tube outer surface L₁ (mm) | 900 | 1000 | 1200 | 1000 | 1000 |
| Exposed length of tube inner surface L₂ (mm) | 930 | 1030 | 1230 | 1030 | 1030 |
| Exposed length of tube inner surface D₁ (mm) | 100 | 100 | 100 | 100 | 100 |
| Tube inner diameter D₂ (mm) | 60 | 60 | 60 | 50 | 70 |
| L₁ / D₁ | 9.0 | 10.0 | 12.0 | 10.0 | 10.0 |
| L₂ / D₂ | 15.5 | 17.2 | 20.5 | 20.6 | 14.7 |
| Change in head height of molten metal(mm) | 67(2) | 42(3) | 21(3) | 36(3) | 51(2) |
| (under condition of passing amount of 40 | | | | | |
| ton/tube) | | | | | |
| Amount of molten metal passing (ton/tube) until | 59.2(2) | 69.8(3) | 89.3(3) | 73.8(3) | 65.0(3) |
| predetermined change in head height is reached | | | | | |
| Comprehensive evaluation of filtration | B(4) | A(6) | A(6) | A(6) | B(5) |
| performance of tubes | | | | | |

| | Ex. 1C | Ex. 2C | Ex. 3C |
|---|---|---|---|
| Exposed length of tube outer surface L₁ (mm) | 800 | 820 | 820 |
| Exposed length of tube inner surface L₂ (mm) | 830 | 850 | 850 |
| Exposed length of tube inner surface D₁ (mm) | 100 | 80 | 100 |
| Tube inner diameter D₂ (mm) | 60 | 40 | 60 |
| L₁ / D₁ | 8.0 | 10.3 | 8.2 |
| L₂ / D₂ | 13.8 | 21.3 | 14.2 |
| Change in head height of molten metal(mm) | 110(1) | 120(1) | 104(1) |
| (under condition of passing amount of 40 | | | |
| ton/tube) | | | |
| Amount of molten metal passing (ton/tube) until | 49.5(1) | 32.1(1) | 50.4(2) |
| predetermined change in head height is reached | | | |
| Comprehensive evaluation of filtration | C(2) | C(2) | C(3) |
| performance of tubes | | | |

As is clear from the results shown in Table 1, it was demonstrated that by using the molten metal filtration unit including the ceramic filtration tube that satisfies the relational expressions (1) L₁/D₁≥8.5 and (2) L₂/D₂≤21 according to the present invention, stable filtration performance was achieved while sufficiently securing the amount (flow rate) of the molten metal passing through, and the life of the filtration tubes was significantly improved, as compared with the case where any one of these relational expressions was not satisfied.

### INDUSTRIAL APPLICABILITY

The molten metal filtration unit of the present invention can simultaneously achieve further increase in the amount of molten metal passing and stable filtration under the increased amount of molten metal passing, and further extension of the service life of the filtration tubes while highly maintaining the strength of the side plates, and it is possible to obtain an advantage that the amount of treatment in the molten metal filtration unit can be increased and the treatment efficiency can be improved. Therefore, it can be suitably used in the form of a molten metal filtration apparatus placed in a filtration chamber to remove inclusions from a molten metal such as aluminum.

### REFERENCE SIGNS LIST

1 Molten metal filtration unit
2A Side plate placed on discharging side
2B Side plate opposite to discharging side
2e Through holes made in side plate placed on discharging side
3 Ceramic filtration tube
3a Outer end surface at second end portion of filtration tube
3b Inner end surface at second end portion of filtration tube
3c Portion of inner surface of filtration tube exposed to molten metal
3d Portion of outer surface of filtration tube exposed to molten metal
3e Opening at first end portion of filtration tube
3w End surface at first end portion of filtration tube
4A Packing for fixing first end portion of filtration tube
4B Packing for fixing second end portion of filtration tube
L₁ Longitudinal length of portion of outer surface of filtration tube exposed to molten metal
L₂ Longitudinal length of portion of inner surface of filtration tube exposed to molten metal
D₁ Outer diameter of filtration tube
D₂ Inner diameter of filtration tube
D₂ₓ Inner diameter of filtration tube at second end portion
D_{2y} Inner diameter of filtration tube at first end portion
Sᵢ Inner diameter of filtration tube arrangement side end of through hole made in side plate placed on discharging side
Sᵢᵢ Inner diameter of discharging side end of through hole made in side plate placed on discharging side
5 Filtration chamber
6 Filter bed
6A, 6B Pedestals provided on hearth
7 Filtration chamber housing
I Entrance port for molten metal into filtration chamber
O Discharging port for molten metal from filtration chamber
T₀ Height of molten metal head in filtration chamber at start of filtration
T₁ Height of molten metal head after passing 40 tons of molten metal per one filtration tube

1. A molten metal filtration unit, comprising:
two or more cylindrical ceramic filtration tubes arranged approximately in parallel and each having an approximately circular cross-sectional shape perpendicular to a longitudinal direction on an outer surface and an inner surface; and
a pair of side plates arranged at both ends of the two or more ceramic filtration tubes in the longitudinal direction,
wherein
the two or more ceramic filtration tubes each has a first end portion on a side from which a molten metal exits and a second end portion on the other side, and
when a length in the longitudinal direction of a portion exposed to the molten metal on an outer surface of the filtration tube is L₁, an outer diameter of the filtration tube is D₁, a length in the longitudinal direction of a portion exposed to the molten metal on an inner surface of the filtration tube is L₂, and an inner diameter of the filtration tube is D₂, at least one of the two or more ceramic filtration tubes satisfies both of the following two relational expressions:
L₁/D₁≥8.5 (1)
L₂/D₂≤21. (2)

2. The molten metal filtration unit according to claim 1, wherein an inner diameter at the first end portion of at least one of the two or more ceramic filtration tubes is larger than an inner diameter at the second end portion.

3. The molten metal filtration unit according to claim 2, wherein the inner diameter at the first end portion of at least one of the two or more ceramic filtration tubes is 100.5% or more and 120% or less of the inner diameter at the second end portion.

4. The molten metal filtration unit according to claim 1, wherein in at least one of the two or more ceramic filtration tubes, an opening shape of the first end portion includes an opening shape of an end portion on the filtration tube arrangement side of an approximately circular through hole made in the side plate placed on the discharging side of the pair of side plates when viewed in the longitudinal direction.

5. The molten metal filtration unit according to claim 4, wherein an inner diameter of an end portion on the discharging side is smaller than an inner diameter of an end portion on the filtration tube arrangement side in the through hole of the side plate placed on the discharging side.

6. The molten metal filtration unit according to claim 5, wherein the inner diameter of the end portion on the discharging side is 80% or more and 99.5% or less of the inner diameter of the end portion on the filtration tube arrangement side in the through hole of the side plate placed on the discharging side.

7. The molten metal filtration unit according to claim 1, wherein at least one of the two or more ceramic filtration tubes is fitted and fixed to a recess bored in the side plate via a packing having a shape conforming to the recess at each end portion in the longitudinal direction.

8. The molten metal filtration unit according to claim 1, wherein at least one of the two or more ceramic filtration tubes is formed of a porous material having a porosity of 25% or more and 50% or less.
